(19) United States
(12) Patent Application Publication
(10) Pub. No.: US 2003/0154088 A1
(43) Pub. Date: Aug. 14, 2003

(54) System for purchasing, managing, and monitoring sophisticated office equipment

(76) Inventors: Rodney Davis, Boise, ID (US); Ethan Davis, Boise, ID (US); Hannah Recla, Ontario, OR (US)

Correspondence Address: ROBERT A. HUNTSMAN, 4466 S. RIVA RIDGE WAY, BOISE, ID, 83709, US

(21) Appl. No.: 10/073,507

(22) Filed: Feb. 8, 2002

(51) Int. Cl. G06F 17/60

(52) U.S. Cl. 705/1

(57) ABSTRACT

This invention teaches a system and method for managing and monitoring the purchase and maintenance of sophisticated office equipment. In the preferred embodiment, consumers, vendors, and administrators are software linked, preferably by an internet, such that the administrator can interface between the consumer and vendor to assist the consumer in reviewing available equipment from multiple vendors prior to the sale. After the sale, the administrator provides an interface between the consumer and vendors to monitor the equipment and manage vendor performance on behalf of the client.

### BACKGROUND OF THE INVENTION

Historically, businesses have relied on sophisticated office machines such as copiers to manage business documents. Modern businesses frequently rely on an increasing number of sophisticated office machines to conduct and manage business affairs. Photocopy machines and numerous other machines including facsimile machines, printers, scanners, telephonic equipment, computers and computer networks are commonplace in many businesses. Modern business enterprises must deal with both more sophisticated machines and a larger number of such machines per office than ever before. To further complicate matters, there are many variations of different machines that can perform more than one function. For example, it is not uncommon to have a single machine that serves as a computer printer, a scanner, and a facsimile machine. Because of the complexity of these machines, businesses frequently rely on outside expert help to help them select, maintain, monitor, and manage their office equipment.

Determining the right mix of equipment, often from multiple vendors, is a daunting task for consumers who use such equipment. Consumers of sophisticated office equipment and machines typically comprise owners and employees of both small and large business enterprises. In order to evaluate a new machine purchase, a consumer must present vendors with proper paperwork specifying requirements and requesting price quotations. After receiving responses from one or more vendors, the quotations need to be reviewed, and a purchase decision is made. The purchase decision is just the first of many difficult decisions a consumer must make. In order to exercise due diligence in many such purchases, additional tasks, such as preparing a contract that properly records consumer expectations and vendor promises, and monitoring the equipment after it is installed is prudent. Furthermore, following up with one or more vendors to ensure they are performing the service functions they agreed to at purchase time is also prudent.

Unfortunately, the consumers who purchase such equipment typically have businesses of their own to conduct and manage and rarely have both the manpower and the desire to adequately perform these tasks. Dedicating the required resources to manage the sophisticated office equipment under modem business conditions is nearly impossible for small and large enterprises alike. Small enterprises rarely have the personnel to manage the equipment. Although larger enterprises may have personnel to oversee sophisticated office equipment purchases and maintenance, such enterprises typically deploy a very large number of units of sophisticated office equipment. In a large enterprise, often a multi-site company, the scope of the problem is magnified exponentially, making it very difficult for the consumer of sophisticated office machines to perform the due diligence necessary to manage these significant assets.

What is needed is a system that allows small and large enterprises alike to efficiently investigate, purchase, and monitor sophisticated office equipment on an enterprise wide basis.

### BRIEF SUMMARY OF THE INVENTION

The present invention teaches a method and system that coordinates investigating, purchasing, managing, and monitoring sophisticated office equipment in a novel way. Specifically, a system comprised of several key subsystems and tools, integrated in a particular manner, is taught. The preferred embodiment focuses on copiers and other document production equipment, and uses the internet to provide the required connectivity. The invention is not limited to this one embodiment, however. The teachings of the present invention are applicable to any sophisticated equipment requiring significant after-the-sale monitoring.

### BRIEF DESCRIPTION OF THE DRAWINGS

FIG. 1 illustrates generally the relationship between consumers, consultants, vendors and administrators according to the present invention.

FIG. 2 illustrates generally the communication paths between consumers, consultants, vendors and administrators according to the present invention.

FIG. 3. illustrates the organization and relationship of tools that comprise the preferred embodiment of the present invention.

FIG. 4. illustrates generally the organization of the acquisition module and the management module according to the present invention.

FIG. 5. illustrates generally the organization of the administration according to the present invention.

### DETAILED DESCRIPTION

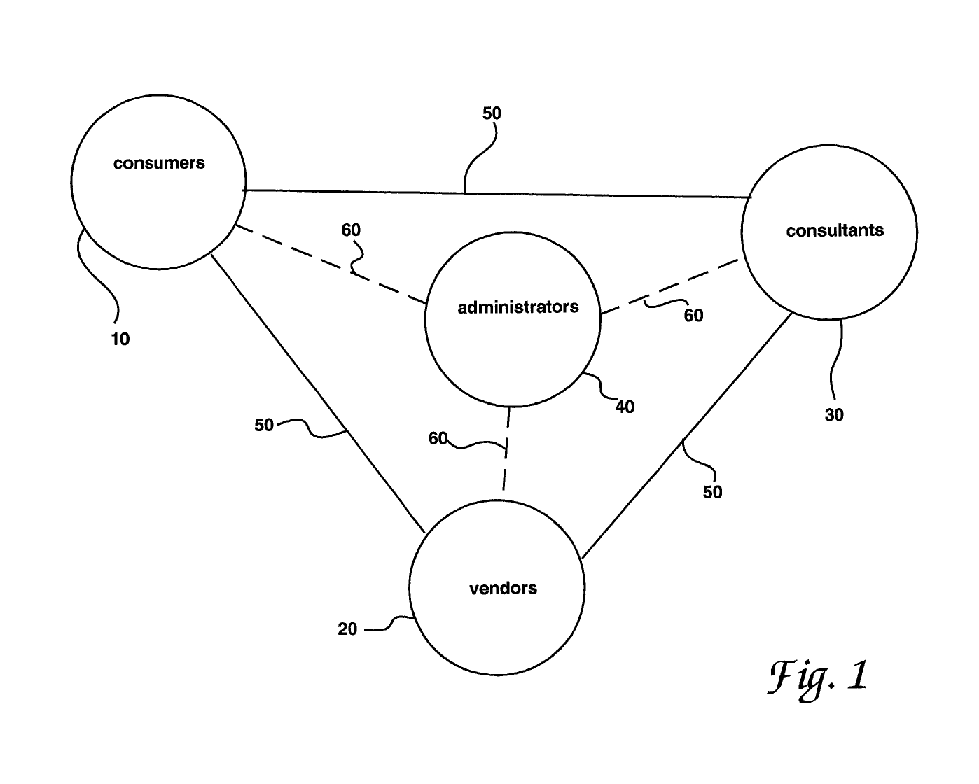

The invention is realized by integrating novel business procedures and processes with specific subsystems, integrated with a network, preferably a computer network. FIG. 1 generally shows a broad view of the system. Referring to FIG. 1, the four groups of users of the system, consumers 10, vendors 20, consultants 30, and administrators 40, are shown generally. The system provides for collaboration between consumers 10, vendors 20, and consultants 30 by providing appropriate interfaces 50. A fourth interface 60 for administrators 40 is provided. The solid lines 50 indicated interfaces between each pair of consumers 10, vendors 20, and consultants 30. The administrator 40 interfaces differently in that the administrator 40 can interface with each of the other groups generally as shown by the dotted lines 60. In addition, administrators 40 can act as a proxy for each of consumers 10, vendors 20 and consultants 30, when interacting with the system. This allows traditional business communications such as telephone calls, facsimile transmissions, and personal visits to be used for communication purposes, particularly to and from the system administrators 40; the system administrators can then relay that information to the system.

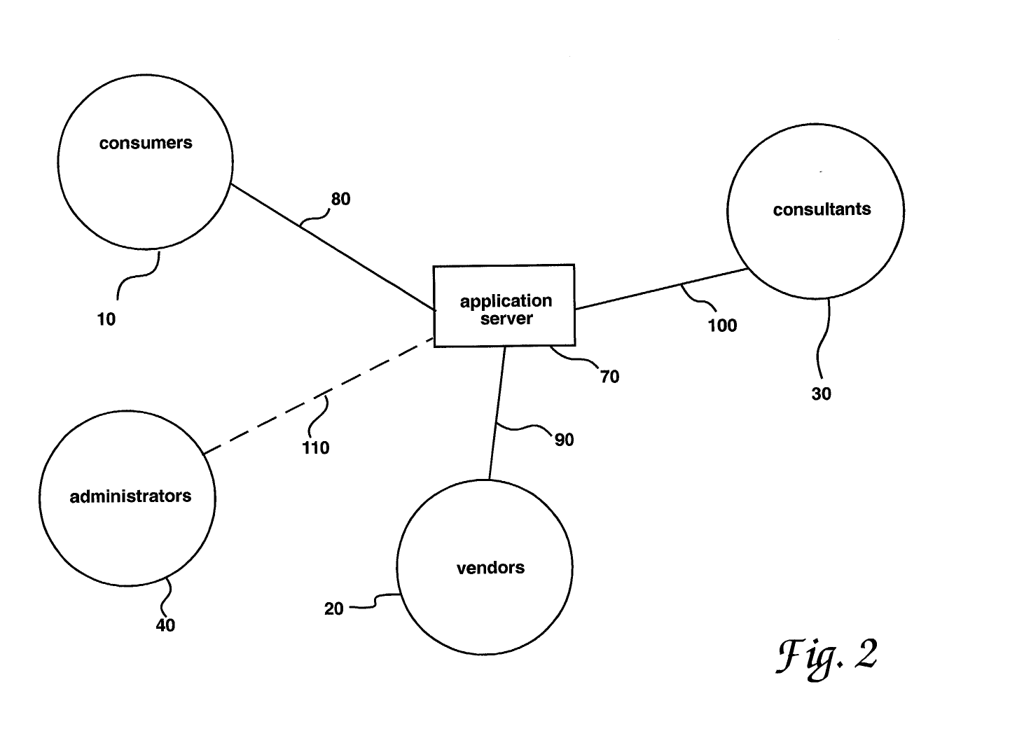

When using the invention, communication does not typically occur directly between consumers 10, vendors 20, and consultants 30. Referring to FIG. 2, a centralized application server 70 is deployed that serves as a communications hub. Consumers 10, vendors 20, and consultants 30 each interface with the centralized application server 70 with their own bidirectional communication interface, depicted as 80, 90, and 100 respectively. The administrators 40 also enjoy a bidirectional communications interface 110 with the centralized application server 70. When the system administrators 40 are serving in a proxy role for consumers 10, vendors 20, or consultants 30, the system can perform a communication through interface 110 that causes the centralized server 70 to function as if a specified communication came directly from consumers 10, vendors 20, or consultants 30, through the respective interfaces 80, 90, or 100.

The communications infrastructure described in FIG. 1 and FIG. 2 provides a basis for providing numerous specialized business application services that require managed interaction between consumers, vendors, and consultants. In particular, in the preferred embodiment of the invention, this infrastructure can host a highly efficient office machine management system.

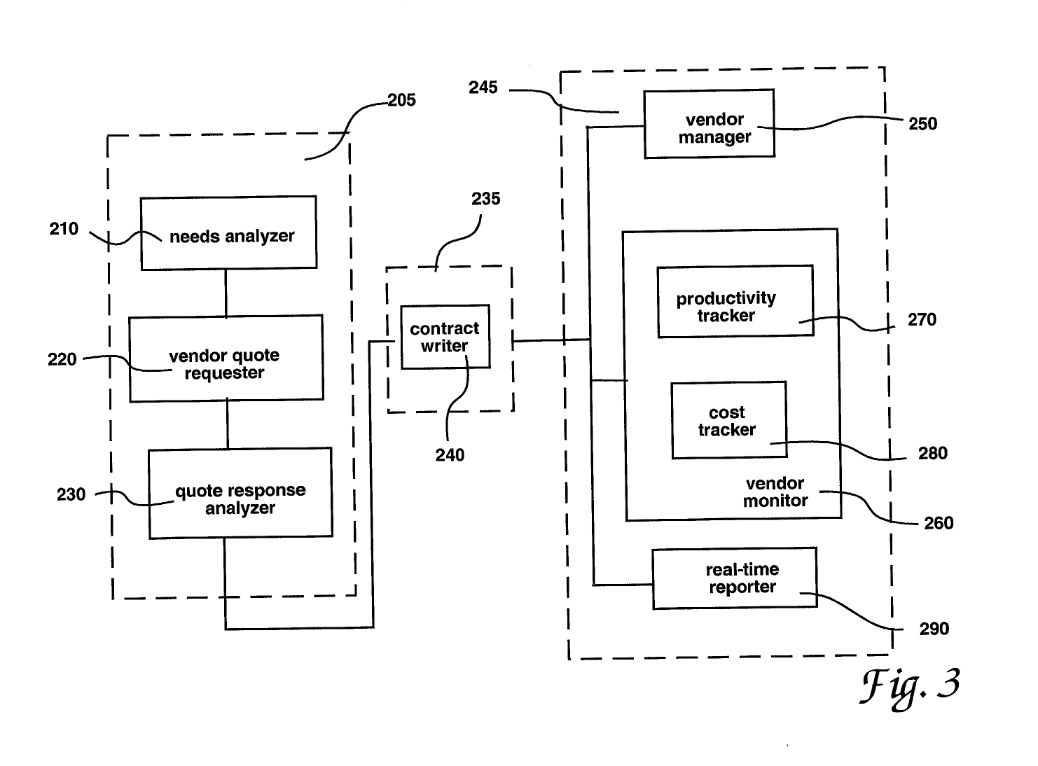

FIG. 3 illustrates the preferred embodiment of such a highly efficient office machine management system. FIG. 3 shows groups of tools needed to deploy the system. The first group 205 depicts tools and processes that a consumer needs to assist in making an informed, optimal purchasing decision. In this embodiment, the tools of the first group 205 include a needs analyzer 210 in which a consumer recognizes and identifies particular needs to be addressed and satisfied by purchased or leased equipment. After needs are identified, a consumer needs a way to present those requests to one or more vendors. In the present invention, this is realized by the vendor quote requester 220 of FIG. 3. After request for quotes are presented to the respective vendors, the vendors generally respond with a quotation. The various quotations from the vendors need to be analyzed so that the consumer can make an informed purchasing or leasing decision. The present invention provides for such a tool, the quote response analyzer 230 of FIG. 3.

The second group of tools 235 of FIG. 3 are those tools needed to memorialize the purchase decision. In the preferred embodiment, that group contains a single tool, a contract writer 240. The contract writer 240 produces a contract containing the agreed terms, including the equipment to be purchase or leased, the specifications of such equipment, and important after-the-sale services to be provided by the vendors.

The third group of tools 245 address after-the-sale functions. This group includes a vendor manager 250, a vendor monitor 260, and a real-time reporter 290. The vendor monitor 260 monitors measurable performance parameters to determine if contract terms resulting from 240 as in being met, and, if, not, initiate corrective procedures. The vendor manager 250 includes facilities to contact vendors 20 and consumers 10 in a number of ways and for a number of different purposes. The vendor monitor 260 includes a productivity tracker 270 and a cost tracker 280.

In general, vendor monitoring includes tasks such as collecting the information for a specific piece of equipment, entering that data into the system, ensuring the data gathered corresponds to the identified equipment, running internal reports, and gathering more information as needed. Managing vendors includes tasks such as contacting the vendor 20 either directly by the consumer 10 or indirectly by the administrator 40 to discuss an issue identified by monitoring. This contact can take the form of phone calls, emails, faxes, and traditional mailed letters.

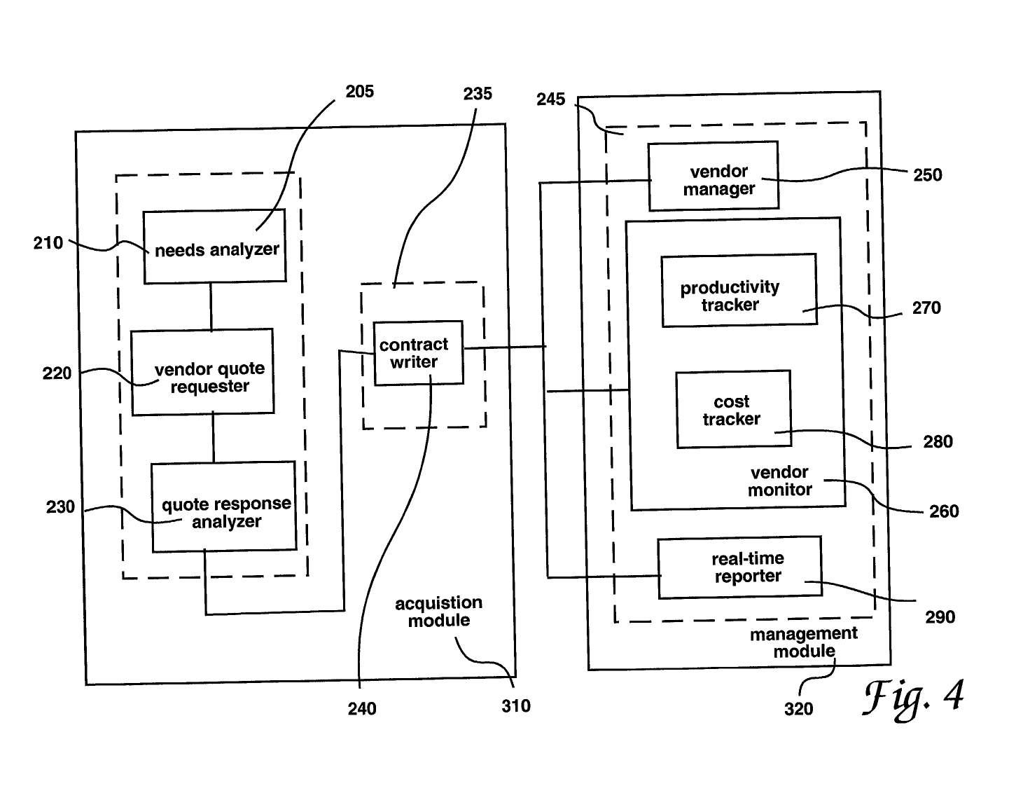

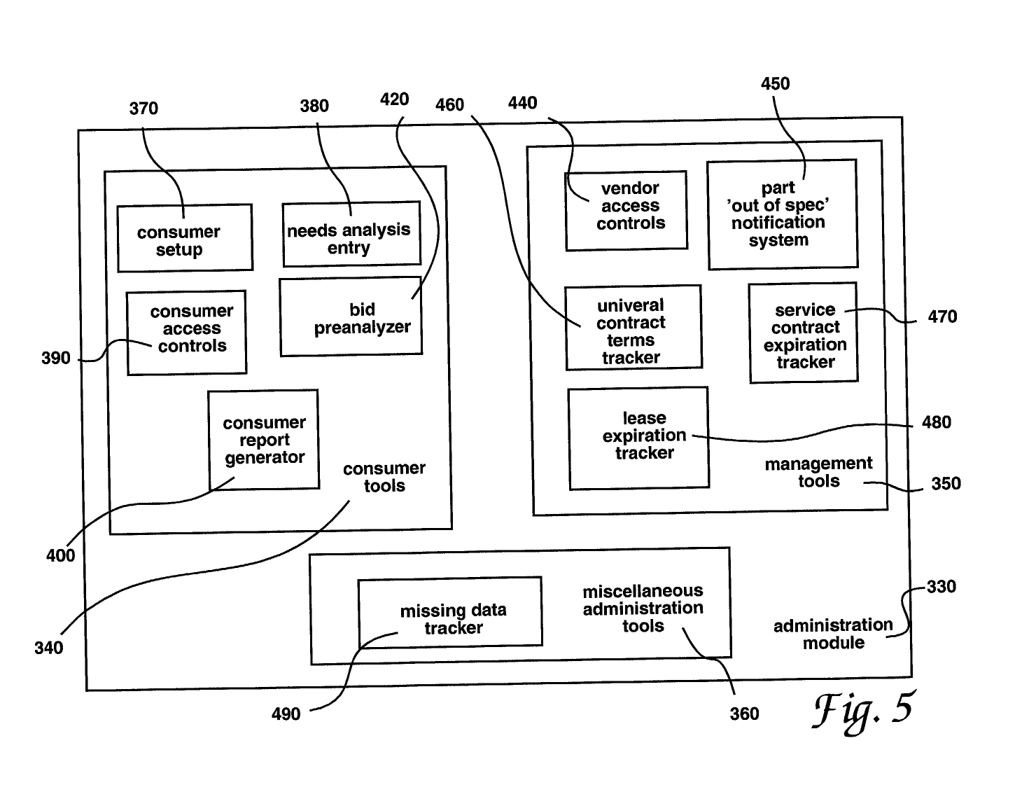

In the preferred embodiment, the invention is embodied in a number of server 16 based software modules, interconnected via an internet. In the preferred embodiment, the consumers 10 are clients of the administrator 40. The modules of the preferred embodiment are an acquisition module, a management module and an administration module. FIG. 4 illustrates generally the acquisition module and the management module. FIG. 5 illustrates generally the administration module. Referring to FIG. 4, the acquisition module 310 includes most of the consumer tools of group 205 of FIG. 3, namely, the needs analyzer 210, the vendor quote requester 220, and the quote response analyzer 230. The contract writer 235 is also part of the acquisition module 310. The management module 320 includes most of group 245 of FIG. 3, namely the vendor manager 250, the vendor monitor 260, including the productivity tracker 270, the cost tracker 280 and the real-time reporter 290.

FIG. 5 shows generally the administration module 330. Referring to FIG. 5, the administration module generally contains three group of administrative tools: consumer administrative tools 340, vendor management administrative tools 350, and miscellaneous administrative tools 330. The consumer administrative tools 340 includes a consumer setup tool 370 whereby consumers are added to the system, and a needs analysis entry tool 380 where identified needs are entered into the system. Additional consumer administrative tools 340 include consumer access controls 390 to restrict access to authorized consumers, a consumer report generator 400 to generate a number of consumer useful reports, and a bid preanalyzer 420 to check the entered data for internal data consistency.

The vendor management administrative tools 350 include vendor access controls 440 to restrict access by vendors 20 to those areas specifically allowed for that vendor 20. Also included is a ‘part out of spec’ notification system 450 that prepares and delivers appropriate automated response notification messages when appropriate. The vendor management administrative tools 350 also includes a universal contract terms tracker 460 for tracking those items common to nearly all vendors, a service contract expiration tracker 470 to monitor expiration dates in an orderly way, and an analougous lease expiration tracker 480.

The miscellaneous administration tools 360 includes tools not appropriate to the other groups. Included in FIG. 5 is a missing data tracker 490 for detecting data missing throughout the administration module 330.

Operational Examples of the Invention

The operation of the invention thus taught realizes a number of useful benefits, described herein. These examples are included by way of illustration, not limitation. When a consumer provides the system with his or her equipment needs, typically through the needs analysis entry tool 380, the system can generate request for quotations (RFQ's). The vendor quote requester 220, in conjunction with the needs analyzer 210, prepares request for quotations which may be customized to each vendor's requirements. The vendor quote requester tool 220 can present the requests to the vendors either on-line or, if necessary, by traditional business communication methods such as mail or facsimile machines. Each vendor 20 who chooses to respond does so by providing a bid and other required information, such as specifications of the equipment being proposed. The responses are then analyzed by the quote response analyzer 220. In the preferred embodiment, each response entered into the system by each vendor for each RFQ can be viewed by the corresponding consumers 10 in a number of ways. For example, the consumer 10 can choose to view responses by all vendors 20, one vendor 20, or view two vendors 20 side by side. In the analysis, each vendor 20, and that vendor's information, is shown in a row. The columns contain vendor supplied information, which may include things like machine pricing, phone numbers and names of references the vendors have provided. Each answer that the vendor enters in response to the RFQ, where feasible, has a column for a side-by-side analysis. The columns all line up with multiple vendors, so in one column, for example, machine pricing for each vendor listed is displayed, and in another column, percentage markdown from the retail price of the equipment is displayed.

Another useful operational benefit is monitoring contract terms for consumers 10 using the system. Vendors 20 answer specific questions in the bid process such as agreeing to replace parts as per manufacturer's recommended yields, which are maintained in the preferred embodiment of the invention. When a part is replaced, it is entered into the system. The system can then identify how many copies are on a specific part since its last replacement, and if in fact that falls within the manufacturer's recommendations.

Another useful operational benefit is tracking vendor response times for consumers 10 using the system. In the preferred embodiment, vendors 20 are required to give an average and maximum response time in the RFQ, and the system tracks both the time that a specific service call is placed by a consumer 10 and the time that the vendor service tech arrives to address that problem. In some cases, vendors 20 agree to pay a response time penalty, typically a percentage of the monthly service bill, if they fail to meet their objectives.

Another important contract term that can be tracked is “copies between calls” (CBC's). This is a measurement that the vendor agrees to in the RFQ, and if the target, for example is 50,000 CBCs per month, and that target is not met, the contract typically will state that, at the consumer's discretion, the machine can be replaced on a like-for-like basis. The system can track these CBC's, and can show a consultant or consumer, at any given time, what vendor-provided equipment is running in CBC's at any given moment.

The needs analyzer 210 considers all aspects of input, processing, and output related to document production. The needs analyzer 210 may consider equipment hardware issues such as network protocols, connections, and software. The needs analyzer 210 determines issues that are important in light of the particular implementation and environment the equipment will be placed in. These issues are dependent on both consumer information that consultants 30 or system administrators 40 may provide (such as information and suggestions on time-saving new features), as well as consumers' plans for the future of their new equipment. Other issues such as “acquisition terms and conditions” and “service terms and conditions” are issues that are considered important for every consumer 10 in the preferred embodiment.

Consumers 10 can access the system to get key information such as total average annual costs, copy volumes, lease and service contract expiration dates, and copies-between-calls. The consumer 10, using the system, can analyze machines that are out of specification with the vendor responses to the RFQ terms and conditions questions. The management module also shows parts out of specification, current contract analyses, average monthly volumes, and serial numbers for each machine in the system.

For the system reporter to work well, items to be reported need to be included in RFQ's. Important items included in almost all RFQ's are most fields typically specified in either “acquisition terms and conditions” or “service terms and conditions” which are set up so that we can provide both analysis of the RFQ and Management Services. Examples of such items includes standard 90 day warranty, money back guarantee time, machine performance for 60 months or set # of impressions, CBC Guarantee, providing manufacturer recommended parts replacement schedules, service response, service response time penalty, and provided loader equipment if a provided piece of equipment is out of service for more than a specified period of time such as 8 hours. Additional examples are copies run by servicing technician credited back to consumer, replacement of all parts according to manufacturer's preventive maintenance schedule, number of factory trained technicians, and independent monitoring of service work.

In the preferred embodiment, vendors 20 access the on-line acquisition module 310 to enter bids for specific RFQs they have been granted access to. In the preferred embodiment, vendors 20 may have restricted access to the management module 320.

Following are some operation examples of how an administrator might use the administration module 330. The administration module 330 can be used to set up consumer contract information (name, address, telephone, etc.), enter need analysis, set up vendor contact information (name, address, telephone, etc.), grant vendors access to RFQs, grant consumers access to both the acquisition module and the management module, pre-analyze bids for completeness, generate reports for consumers, generate internal ‘information missing reports’, track all contract terms and conditions for every machine in the system from one screen. The administrator can generate automatic “parts out of spec” facsimiles that are transmitted to vendors with corresponding notification letters to consumers, check vendor-consumer invoices, track service contract expiration dates, and lease expiration dates.

The administrator 40 can perform operations on behalf of the consumer 10. A consumer 10 typically transmits by mail or facsimile all available paper work, such as service history and any service call records to the administrator 40. The consumer can check on any of their machines at any time.

When the administrator receives new information, and at scheduled intervals, the administrator performs a monitoring check on all machines. When the administrator 40 receives any information on a specific machine, the machine is checked for compliance against every “term and condition” specific to it. Every machine can be checked for compliance against every “term and condition” specific to it periodically, such as once a week, by the administrator 40. When a performance issue is identified, the administrator 40 first contacts the consumer 10 to alerts them. The consumer 10 can then contact the vendor 40 directly, if necessary, with the information provided by the system through the administrator 40 to get the issue resolved. In the preferred environment, if the issue is not resolved in this manner, the administrator 40, the consumer 10, and vendor 20 may meet to resolve the problem.

In the preferred embodiment, information for the monitoring is gathered in a variety of ways. Every time a machine receives service by a technician from the vendor 20, the consumer 10 faxes the paperwork given to them about the service call by the technician. Consumers 10 can request complete service histories from their vendor 20, as well as manufacturer recommended parts impressions and preventive maintenance schedules, and then transmit it by mail or facsimile to the administrator 40. The administrator 40 enters the information into the system.

In another embodiment, independent consultants 30 do person-to-person information gathering from consumers 10 and vendors 20 and complete a needs analysis using an administrator provided form. The administrator 40 enters the collected information into the system. Once the information is entered, the consultant 30 has access to all appropriate consumer views and vendor views, and the consultant 30 uses the system to manage the bidding process as well give access to the consumers 10 who are clients of the consultant 30. In this embodiment, the management module 320 is operated by the administrator 40.

Although the technology is currently contemplated in office environments, the technology is applicable elsewhere. For example, the technology could be deployed analogously in virtually any environment where maintenance is tracked by a counter, such oil changes tracked by odometer readings in a car.

The above description is provided to illustrate the design and operation of the invention in several embodiments. The invention can be realized in a number of embodiments not specifically shown. The invention is limited only by the claims as set forth below.

We claim:

1. A method for managing sophisticated office machines in an environment having consumers and vendors comprising the steps of:
associating a needs analyzer with the environment,
associating a vendor quote requester with the environment,
wherein the needs analyzer is software coupled to the vendor quote requester, the needs analyzer determines a list of needs of a consumer, and the vendor quote requester prepares input screens reflecting the list of needs.

2. The method of claim 1 further comprising the steps of:
associating a vendor monitor with the environment,
wherein vendor performance parameters are measured.

3. The method of claim 1 further comprising the steps of:
associating a quote response analyzer with the environment,
wherein a plurality of vendor responses are collected for viewing or further processing.

4. The method of claim 2 further comprising the steps of:
associating a vendor management module with the environment, associating an administrative module with the environment,
wherein the vendor management monitor includes the vendor monitor,
wherein the vendor management module is coupled to the administrative module.

5. The method of claim 2 further comprising the steps of:
associating a quote response analyzer with the environment,
wherein a plurality of vendor responses are collected for viewing or further processing.

6. The method of claim 4 wherein the administrative module receives performance parameters from the vendor management module and manages the vendor based on the performance parameters.

7. The method of claim 4 further comprising the steps of:
associating a quote response analyzer with the environment,
wherein a plurality of vendor responses are collected for viewing or further processing.

8. The method of claim 4 further comprising the steps of:
associating a contract writer with the environment,
associating a vendor manager with the management module,
associating a productivity tracker with the management module,
associating a cost tracker with the management module,
associating a realtime management reporter with the management module,
wherein the contract writer produces a suitable contract based on an accepted quotation, the vendor manager is deployed to contact a vendor when a problem arises, the productivity tracker and the cost tracker maintain useful statistics that can be reported on demand by the realime management reporter.

9. The method of claim 6 further comprising the steps of:
associating a quote response analyzer with the environment,
wherein a plurality of vendor responses are collected for viewing or further processing.

10. The method of claim 6 further comprising the steps of:
associating a contract writer with the environment,
associating a vendor manager with the management module,
associating a productivity tracker with the management module,
associating a cost tracker with the management module,
associating a realtime management reporter with the management module,
wherein the contract writer produces a suitable contract based on an accepted quotation, the vendor manager is deployed to contact a vendor when a problem arises, the productivity tracker and the cost tracker maintain useful statistics that can be reported on demand by the realime management reporter.

11. The method of claim 9 further comprising the steps of:
associating an acquisition module with the environment,
wherein the acquisition module is coupled to the administrative module.

12. The method of claim 9 wherein the acquisition module includes the needs analyzer,
the vendor quote requester, and the quote response analyzer.

13. The method of claim 9 further comprising the steps of:
associating a contract writer with the environment,
associating a vendor manager with the management module,
associating a productivity tracker with the management module,
associating a cost tracker with the management module,
associating a realtime management reporter with the management module,
wherein the contract writer produces a suitable contract based on an accepted quotation, the vendor manager is deployed to contact a vendor when a problem arises, the productivity tracker and the cost tracker maintain useful statistics that can be reported on demand by the realime management reporter.

14. The method of claim 11 wherein the acquisition module includes the needs analyzer,
the vendor quote requester, and the quote response analyzer.

15. The method of claim 11 further comprising the steps of:
associating a contract writer with the environment,
associating a vendor manager with the management module,
associating a productivity tracker with the management module,
associating a cost tracker with the management module,
associating a realtime management reporter with the management module,
wherein the contract writer produces a suitable contract based on an accepted quotation, the vendor manager is deployed to contact a vendor when a problem arises, the productivity tracker and the cost tracker maintain useful statistics that can be reported on demand by the realime management reporter.

16. The method of claim 14 further comprising the steps of:
associating a contract writer with the environment,
associating a vendor manager with the management module,
associating a productivity tracker with the management module,
associating a cost tracker with the management module,
associating a realtime management reporter with the management module,
wherein the contract writer produces a suitable contract based on an accepted quotation, the vendor manager is deployed to contact a vendor when a problem arises, the productivity tracker and the cost tracker maintain useful statistics that can be reported on demand by the realime management reporter.

17. A system for managing sophisticated office machines in an environment having consumers and vendors comprising:
a needs analyzer,
a vendor quote requester,
wherein the needs analyzer is software coupled to the vendor quote requester, the needs analyzer determines a list of needs of a consumer, and the vendor quote requester prepares input screens reflecting the list of needs.

18. The system of claim 17 further comprising:
a vendor monitor,
wherein vendor performance parameters are measured.

19. The system of claim 17 further comprising:
a quote response analyzer,
wherein a plurality of vendor responses are collected for viewing or further processing.

20. The system of claim 18 further comprising:
a vendor management module, an administrative module,
wherein the vendor management monitor includes the vendor monitor,
wherein the vendor management module is coupled to the administrative module.

21. The system of claim 18 further comprising:
a quote response analyzer,
wherein a plurality of vendor responses are collected for viewing or further processing.

22. The system of claim 20 wherein the administrative module receives performance parameters from the vendor management module and manages the vendor based on the performance parameters.

23. The system of claim 20 further comprising:
a quote response analyzer,
wherein a plurality of vendor responses are collected for viewing or further processing.

24. The system of claim 20 further comprising:
a contract writer,
a vendor manager,
a productivity tracker,
a cost tracker,
a realtime management reporter,
wherein the contract writer produces a suitable contract based on an accepted quotation, the vendor manager is deployed to contact a vendor when a problem arises, the productivity tracker and the cost tracker maintain useful statistics that can be reported on demand by the realime management reporter.

25. The system of claim 22 further comprising:
a quote response analyzer,
wherein a plurality of vendor responses are collected for viewing or further processing.

26. The system of claim 22 further comprising:
a contract writer,
a vendor manager,
a productivity tracker,
a cost tracker,
a realtime management reporter,
wherein the contract writer produces a suitable contract based on an accepted quotation, the vendor manager is deployed to contact a vendor when a problem arises, the productivity tracker and the cost tracker maintain useful statistics that can be reported on demand by the realime management reporter.

27. The system of claim 25 further comprising:
an acquisition module,
wherein the acquisition module is coupled to the administrative module.

28. The system of claim 25 wherein the acquisition module includes the needs analyzer,
the vendor quote requester, and the quote response analyzer.

29. The system of claim 25 further comprising:
a contract writer,
a vendor manager,
a productivity tracker,
a cost tracker,
a realtime management reporter,
wherein the contract writer produces a suitable contract based on an accepted quotation, the vendor manager is deployed to contact a vendor when a problem arises, the productivity tracker and the cost tracker maintain useful statistics that can be reported on demand by the realime management reporter.

30. The system of claim 27 wherein the acquisition module includes the needs analyzer,
the vendor quote requester, and the quote response analyzer.

31. The system of claim 27 further comprising:
a contract writer,
a vendor manager,
a productivity tracker,
a cost tracker,
a realtime management reporter,
wherein the contract writer produces a suitable contract based on an accepted quotation, the vendor manager is deployed to contact a vendor when a problem arises, the productivity tracker and the cost tracker maintain useful statistics that can be reported on demand by the realime management reporter.

32. The system of claim 30 further comprising:
a contract writer,
a vendor manager,
a productivity tracker,
a cost tracker,
a realtime management reporter,
wherein the contract writer produces a suitable contract based on an accepted quotation, the vendor manager is deployed to contact a vendor when a problem arises, the productivity tracker and the cost tracker maintain useful statistics that can be reported on demand by the realime management reporter.

33. A method for managing sophisticated office machines in an environment comprising the steps of:
associating a consumer access point with the environment,
associating an administrator access point with the environment,
associating a vendor access point with the environment,
wherein the administrator manages the vendor on behalf of the consumer.

34. The method of claim 33 wherein consumer requirements are received by the system at the consumer access point and vendor product quotations are received by the system at the vendor access point.

35. The method of claim 33 wherein an administrator uses the administrator access point to monitor the sophisticated office equipment.

36. The method of claim 33 wherein the environment is a networked business enterprise.

37. The method of claim 34 wherein an administrator uses the administrator access point to monitor the sophisticated office equipment.

38. The method of claim 34 wherein the environment is a networked business enterprise.

39. The method of claim 37 wherein the environment is a networked business enterprise.

40. A system for managing sophisticated office machines in an environment comprising:
a consumer access point,
an administrator access point,
a vendor access point,
wherein the administrator manages the vendor on behalf of the consumer.

41. The system of claim 40 wherein consumer requirements are received by the system at the consumer access point and vendor product quotations are received by the system at the vendor access point.

42. The system of claim 40 wherein an administrator uses the administrator access point to monitor the sophisticated office equipment.

43. The system of claim 40 wherein the environment is a networked business enterprise.

44. The system of claim 41 wherein an administrator uses the administrator access point to monitor the sophisticated office equipment.

45. The system of claim 41 wherein the environment is a networked business enterprise.

46. The system of claim 44 wherein the environment is a networked business enterprise.
